(19) United States
(12) Patent Application Publication
(10) Pub. No.: US 2009/0242753 A1
(43) Pub. Date: Oct. 1, 2009

(54) DEVICE AND MASS ANALYSIS OF MOLECULES USING UV OR VISIBLE LASER BEAM PHOTODISSOCIATION

(75) Inventors: Philippe Dogourd, Dardilly (FR); Rodolphe Antoine, Lyon (FR); Michel Broyer, Lyon (FR); Francis Talbot, Villeurbanne (FR)

Correspondence Address: DENNISON, SCHULTZ & MACDONALD, 1727 KING STREET, SUITE 105, ALEXANDRIA, VA, 22314, US

(73) Assignees: UNIVERSITE CLAUDE BERNARD LYON 1, Villeurbanne (FR); CENTRE NATIONAL DE LA RECHERCHE SCIENTIFIQUE (C.N., Paris (FR)

(21) Appl. No.: 11/721,690

(22) PCT Filed: Dec. 15, 2005
(86) PCT No.: PCT/FR2005/003142

§ 371 Date: Jan. 14, 2008

(30) Foreign Application Priority Data
Dec. 16, 2004 (FR) 0413396

(51) Int. Cl. B01D 59/44; H01J 49/00

(52) U.S. Cl. 250/283; 250/288

(57) ABSTRACT

The invention relates to a device for mass analysis of molecules comprising a quadripolar ion trap equipped with an inlet for injection of molecules to be analysed in ionised form and an outlet for ejection of the ions to be detected, comprising an electrode system for generating a three-dimensional quadripolar field, capable of trapping the molecules to be analysed in ionised form, as a function of their mass to charge (m/z) ratio in a trapping volume, said trap being coupled to a UV or visible laser beam ensuring dissociation of the molecules to be analysed, characterised in that the laser beam is introduced to the trap without passing via fibre optics via an opening made in one of the electrodes, separate from the inlet and the outlet and blocked tightly by a viewing window allowing the laser beam to pass through, the dimension of the viewing window being selected such that the laser beam covers the entire trapping volume, as well as a process for mass analysis, with laser beam dissociation.

The present invention relates to a device and a process for analysis by mass spectrometry of molecules, on the one hand using a quadripolar ion trap and, on the other hand, a UV or visible laser beam, ensuring photodissociation of molecules in ionised form which are trapped inside the quadripolar trap.

In conventional terms, an ion trap on the one hand traps ions in the form of a cloud of stable ions and, on the other hand, conducts their mass analysis. The general principle of a quadripolar ion trap and the process of mass analysis making use of such a trap have been described in the patents U.S. Pat. No. 3,527,939 and U.S. Pat. No. 4,650,999. Classically, a quadripolar ion trap is equipped with an inlet for injection of molecules to be analysed in ionised form and an outlet for ejection of ions to be detected, and comprises an electrode system for generating a three-dimensional quadripolar field, capable of selecting the molecules in ionised form to be analysed, as a function of their (m/z) mass to charge ratio and trapping them in a trapping volume. It is the variations applied to the quadripolar field which allow the ionised molecules to be selected and trapped whereof the m/z ratio was predetermined and which allow the other ions to be rejected. The selected molecules are then ejected to detection means permitting their mass analysis. The process and the device described in this patent allow for no differentiation of molecules of the same m/z ratio.

Mass spectrometry in tandem, which consists of isolating a mass, then fragmenting it by collision with a gas and mass analysis of the fragments obtained, is described in U.S. Pat. No. 4,736,101. This analytical technique is today widely implanted in commercial ion traps and is much used especially in proteomics.

This analytical technique, known as <<Collision Induced Dissociation>> (CID) however has some drawbacks:
First of all, there is competition between the excitation by collision with the gas and ejection of the ions in the trap. This means that the trajectories of the ions are modified during CID, which can lead to a loss of parent ions or fragments and to a drop in mass resolution.
The excitation is non-selective. In fact, the collisions result in overall heating of the molecule which does not depend on its geometric or electronic properties.
This technique has low efficacy for molecules of high m/z ratio.
It calls on statistical mechanisms leading only to the lowest-energy fragmentation channels.

Consequently, an alternative solution has been proposed which consists of exciting the molecules with luminous radiation. The excitation of the molecules is thus independent of their trapping. Infrared multiphotonic dissociation (IRMPD) using CO₂ lasers is described in Anal. Chem. 1996, 68, 4033 and J. Am. Soc. Mass Spectrom., 1994, 5, 886. In the works specified in these publications, the internal energy of the ion is augmented by sequential absorption of a large number of photons, resulting in statistical fragmentations close to those produced by CID, that is, non-selective dissociation is also obtained.

In 1987, Louris et al. (Int. J. Mass. Spectrom. Ion Processes, 1987, 75, 345) proposed utilising a UV laser for conducting photodissociation of trapped ions. In this publication, injection of the UV laser, inside the trap, is done by means of fibre optics. Using fibre optics permits an interface between the laser production means and the relatively simple trap. All the same, the laser beam obtained as it leaves the fibre optics is divergent, and strong energy densities are necessary to obtain satisfactory photodissociation. Also, using fibre optics is not adapted to laser beams in the form of ultrabrief pulses, especially of the order of a few femtoseconds. Furthermore, the laser injected inside the trap can interact with the walls of the trap and cause generation of parasites.

Gabryelski and Li (Rev. Scient. Inst. 1999, 70, 4192) also used an experimental assembly utilising a laser for photodissociation, resulting in low mass resolution. Also, here too, the high-power laser used generates a very large number of parasite ions inside the trap.

More recently, Weinkauf et al. (Phys. Chem. Chem. Phys. 2004, 6, 2633) proposed injecting a laser within a quadripolar ion trap, made up of a ring electrode and two cap electrodes by injecting the laser through holes made in one of the cap electrodes for ejecting the ions to the detection means. It is clear that this assembly does not require any modification of the electrodes, however it is realisable only if the detection means are not located in the axis of introduction of the laser beam. In addition, no alignment of the laser is envisaged such that it is difficult to guarantee that the latter covers the cloud of ions trapped inside the quadripolar trap.

In this context, the present invention aims to provide a device and a process for mass analysis of a sample by using a quadripolar ion trap, for carrying out photo-induced dissociation by visible or ultraviolet laser beam, in turn enabling much more specific dissociation than the CID or infrared multi-photonic dissociation and not having the drawbacks of the prior art.

The object of the present invention is therefore a device for mass analysis of molecules comprising a quadripolar ion trap equipped with an inlet for injection of the molecules to be analysed in ionised form and an outlet for ejection of the ions to be detected, comprising an electrode system which generates a three-dimensional quadripolar field, capable of selecting the molecules to be analysed in ionised form, as a function of their (m/z) mass to charge ratio and trapping them in a trapping volume, said trap being coupled to a UV or visible laser beam ensuring dissociation of the molecules to be analysed in ionised form, characterised in that the laser beam is introduced to the trap, without passing through fibre optics, via an opening made in one of the electrodes, separate from the inlet for injection of the molecules to be analysed in ionised form and from the outlet for ejection of the ions to be detected, and blocked tightly by a viewing window letting the laser beam pass through, the dimension of the viewing window being such that the laser beam covers the entire trapping volume.

Another aspect of the invention is relative to a process for mass analysis of molecules using injection of the molecules to be analysed in ionised form in a quadripolar trap, a selection of the molecules to be analysed in ionised form, as a function of their (m/z) mass to charge ratio and their trapping in a trapping volume, by means of a three-dimensional quadripolar field generated by an electrode system, dissociation of the molecules to be analysed in ionised form trapped in the trapping volume, by means of a UV or visible laser beam, then ejection of the ions to be detected, characterised in that the laser beam ensuring dissociation is introduced to the trap, without passing through fibre optics, via an opening made in one of the electrodes, separate from the inlet for injection of the molecules to be analysed in ionised form and from the outlet for ejection of the ions to be detected, and blocked tightly by a viewing window letting the laser beam pass through and such that the laser beam covers the entire trapping volume.

The present invention is detailed in the following description by reference to the attached figures.

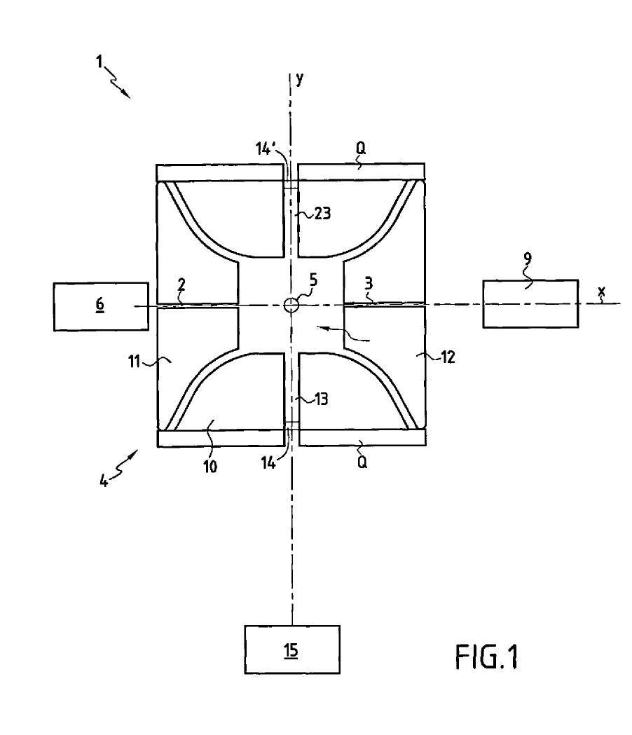

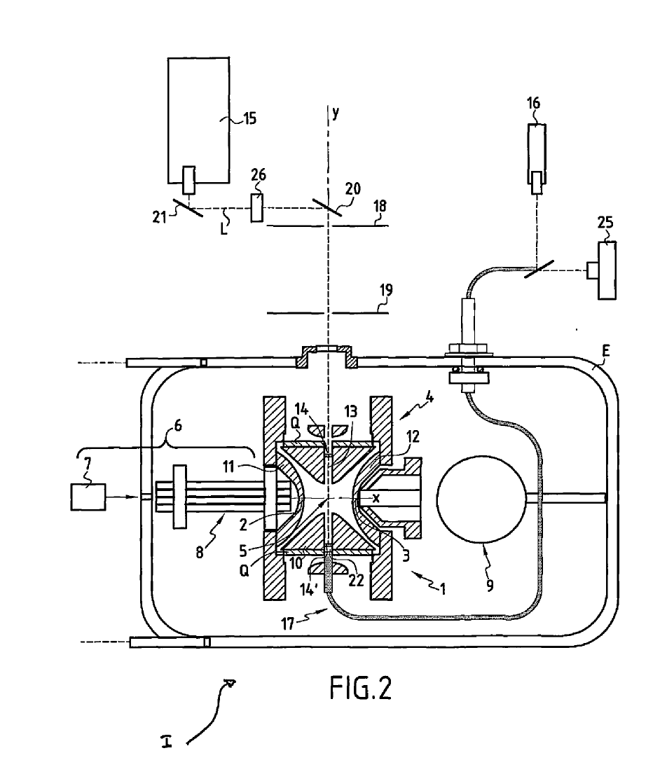

FIGS. 1 and 2 illustrate examples of a device according to the invention.

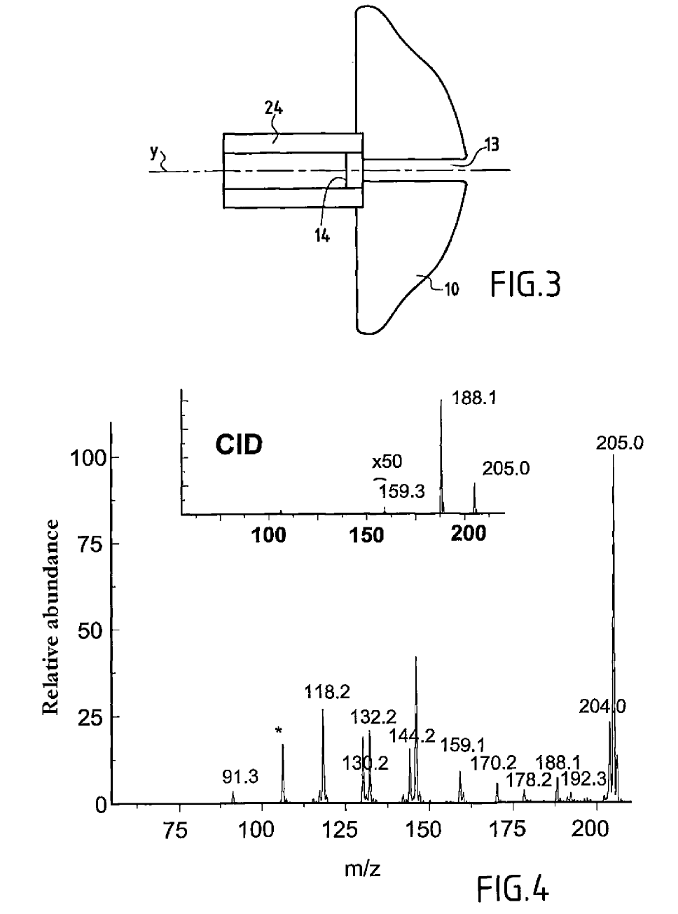

FIG. 3 shows a sectional view of part of the device according to FIG. 2.

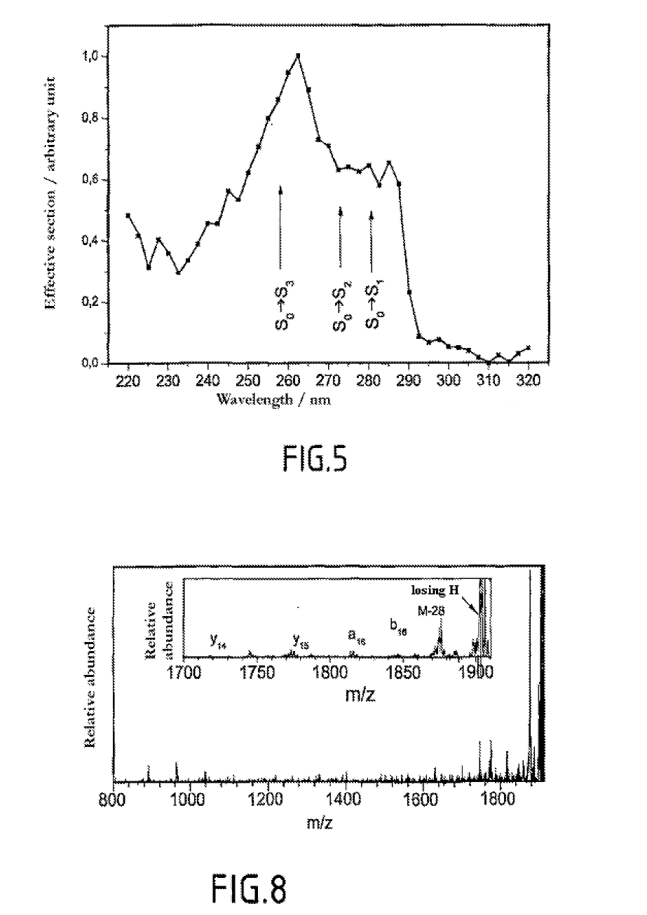

FIGS. 4 to 8 relative to spectra obtained using the device illustrated in FIG. 2 will be detailed in the part of the description relative to the example.

In conventional terms, the device I according to the invention, such as illustrated for example in FIG. 1, utilises a quadripolar ion trap 1 equipped with an inlet 2 for injection of the molecules to be analysed in ionised form and an outlet 3 for ejection of the ions to be detected, comprising an electrode system 4 which generates an three-dimensional quadripolar field capable of selecting the molecules to be analysed in ionised form, as a function of their (m/z) mass to charge ratio and trapping them in a trapping volume 5. The inlet 2 is connected to a series of means 6, first allowing a sample of interest to be ionised and the ionised molecules obtained to be injected inside the trap 1. In the example of device I illustrated in FIG. 2, these means 6 are constituted by an electrospray source 7 coupled to a pair of octopoles 8 connected to the inlet 2 of the trap 1, means classically used in commercial devices. The quadripolar trap 1 is also coupled, at the outlet 3 for ejection of the ions to be detected, to detection means 9 of the ejected ions. These detection means 9 are, for example, constituted by a conversion dynode coupled to an electron multiplier, the ensemble of these detection means capable of being protected a Faraday cage.

The electrode system 4 can be composed of a central annular electrode 10 delimiting a cavity containing the trapping volume 5 and two cap electrodes 11 and 12 situated on either side of the cavity delimited by the annular electrode 10, such as shown in FIG. 2. Spacers Q, for example made of quartz, are positioned such that the electrode system delimits a closed cavity. In conventional terms, the inlet 2 for injection of the molecules to be analysed in ionised form can be made in one of the cap electrodes 11, the outlet 3 for ejection of the ions to be detected being made in the other cap electrode 12. More often than not, the inlet 2 and the outlet 3 will be positioned opposite one another, such that the axis of injection of the molecules to be analysed in ionised form and the axis of ejection of the ions to be detected coincide on an axis x. The diameters of the inlet 2 and of the outlet 3 are very small, of the order of a few hundred μm.

Of course, the device I comprises electronic means for controlling and regulating the quadripolar field to maintain and vary the quadripolar field generated and, thus ensure selection, trapping and/or ejection of molecules of given m/z mass.

According to one of the essential characteristics of the invention an opening 13 is made in one of the electrodes for passage of the laser beam L which will serve as photodissociation of the ions. This opening is blocked tightly by a material permeable (that is transparent) to the laser beam in the form of a viewing window 14, the position of the blockage and the direction y of propagation of the laser beam L being selected such that the laser beam L does not interact inside the trap with injection of the molecules to be analysed in ionised form, nor with ejection of the ions to be detected, and directly reaches the trapping volume 5. The opening 13 is equipped with sealing means ensuring tightness between the viewing window 14 and the electrode in which the opening 13 is made. The dimension of the opening 13 or, more precisely, of the viewing window 14 is, per se, selected such that the laser beam covers the entire trapping volume. The diameter of the laser beam L is effectively directly associated with the dimension of the viewing window 14. The dimension of the opening and above all the dimension of the passage for the laser beam is therefore determined precisely relative to that of the trapping volume 5, such that the value of the transversal section of the laser beam L relative to the axis y is preferably between the value of the transversal section of the trapping volume 5 relative to the axis y and the value of this section +5%. Tight blocking is understood to mean that the opening is closed by a viewing window system 14, for example, in such a way that the pressure conditions and the electrostatic trapping conditions inside the trap 1 are not modified inside the trap, and in particular at the level of and in the vicinity of the trapping volume 5. The tightness of the viewing window 14 and the dimensions of the opening 13 ensure that introduction of the laser beam L does not modify the lines of electrostatic field in which the molecules in ionised form are trapped. The viewing window 14 is made of a material permeable to the laser beam, for example, melted silicon (of UV quality) or is made of sapphire. A source 15 for generating a laser beam L is therefore positioned upstream of the viewing window 14. The opening 13 is sufficiently distant from the inlet and the outlet of the ions for the source 15 to be positioned, taking into consideration the overall size of the ionisation means 6 and the injection means of the ionised molecules on the one hand and the detection means 9 on the other hand. In the case of an electrode system 4 constituted by a ring electrode 10 and two cap electrodes 11 and 12 as indicated hereinabove, the opening 13 for introduction of the laser will be advantageously made in the ring electrode 10. Preferably, introduction of the laser beam L is done according to a direction y perpendicular to the direction x of injection and ejection when they are parallel and aligned.

In the device I of the invention, the laser beam L is not injected by means of fibre optics, allowing substantial adaptability of the device according to the invention to different types of laser beam. In effect, using fibre optics often results in a divergent beam, especially in the case of high-power UV laser, and can function only with a range of wavelengths. It is also remembered that using fibre optics for introducing a UV laser having a wavelength of less than 220 nm is currently quasi excluded. In addition, at high powers, especially for wavelengths of less than 260 nm, solarisation, leading to reversible degradation of the fibre is noted. The device I according to the invention can per se function with a wide range of wavelengths, from visible to UV. The invention is particularly adapted to using a UV laser of a wavelength, especially between 193 and 450 nm. Irrespective of its UV or visible nature, the laser used preferably has a power at least equal to 10 mW and, preferably, between 10 and 100 mW. Also, lasers in the form of very short pulses, of the order of a few nanoseconds, picoseconds or femtoseconds, could be used. It is especially possible to inject ultrashort pulses controlled in phase and amplitude.

According to a preferred variant of the invention, particularly adapted to utilisation of a UV laser beam, the device is equipped with alignment means of the laser beam L on the trapping volume 5. In this case, prior to injecting the molecules to be analysed, an alignment stage of the laser beam on the trapping volume will be completed. In terms of alignment means a photodiode positioned on the selected axis y can be used for example, which is centred on the trapping volume 5, or else means such as illustrated in FIG. 2 and detailed in the example to follow can be used. The alignment means illustrated in FIG. 2 utilise a visible low-power laser source 16 injected by way of fibre optics 17, according to the determined axis y centred on the trapping volume 5 and, in the example illustrated perpendicular to the axis x of injection and ejection of the ions. This visible beam therefore exits via the opening 13 made for introducing the laser beam L to serve as photodissociation and helps to locate the axis y at the outlet by means of two pinholes 18 and 19 positioned centred on the latter. The laser beam L will thus be aligned on this axis y by means of two mirrors 20 and 21.

Of course, here too injection of the laser visible used for alignment within the quadripolar trap 1 is carried out according to a tightly blocked opening 22 in terms such as defined hereinabove, while letting visible light pass through.

According to another embodiment of the invention, an opening 23 blocked tightly by an element permeable to the laser beam used is made in the quadripolar trap 1, so as to allow the outlet of the trap 1 of the laser beam L introduced. In this case, the outlet of the laser beam L introduced to the trap 1 is ensured, thus avoiding, especially in the case of a UV laser, contamination of the analysis results by the presence of ions desorbed from the material making up the internal walls of the trap. In the example illustrated in FIG. 2, the opening 22, made for using alignment means 15, coincides with that 23 made for evacuation of the laser L from the trap 1, since these two openings 22 and 23 must be located in the axis y. In the case of a ring electrode/2-cap system, the opening 13 for introduction of the laser L and those 22 and 23 for its evacuation and its alignment are made in the annular electrode 10, diametrically opposed, as illustrated in FIG. 2. FIG. 3 illustrates sealing means of the opening 13, which can be adapted to the openings 22 and 23. The tightness system, illustrated in FIG. 3, is constituted by a cylindrical adapter 24 from an insulating material, for example, inserted into the opening and having a viewing window 14 made of sapphire (opening 13) or melted silicon of UV quality (opening 22). In the example illustrated the tightness means therefore comprise a tube 24 made of an insulating material whereof one end is blocked by a viewing window 14 made of sapphire or melted silicon of UV quality. The tube 24 engages in a bore, made at the level of the external surface of the electrode and centred on the opening 13, such that the viewing window 14 is aligned with the opening 13. The assemblies of the tube 24 and the viewing window 14, as well as the tube 24 and the electrode 10, are made to be tight. It will be noticed that, according to the example illustrated, the tube 24 has a length greater than the thickness of the viewing window 14 and the diameter of the viewing window 14 is greater than the diameter of the opening 13.

In the case where an opening 23 is provided for the outlet of the laser, it can be provided to arrange, after this outlet, control means 25 for alignment of the laser. These control means 25 are, for example, constituted by a photon detector.

The device I according to the invention also comprises means 26 ensuring synchronisation between the introduction of the laser beam in the trap and trapping of the molecules to be analysed in ionised form. An electromechanical plug could be used for example after the source 15 of the laser beam L. These means 26 will help modulate the duration of the interaction of the molecules to be analysed with the laser. Also, the different electronic control means, on the one hand of the quadripolar field, on the other hand of the laser beam, as well as these synchronisation means, will assist in conducting experiments of type MSN, by successive photodissociations. This means that after initial dissociation, at least one following sequence is implemented: by regulating the three-dimensional quadripolar field generated by the electrode system, selection of molecules to be analysed in ionised form originating from previous dissociation, as a function of their (m/z) mass to charge ratio and trapping of the latter in the trapping volume, then dissociation of the selected molecules in ionised form. It is also possible to couple the process according to the invention with upstream CID analyse.

The quadripolar trap 1, as well as other elements of the device are arranged in an enclosure E, in which the pressure conditions necessary for detection must be maintained. Consequently, the different connections made at the level of the enclosure, for introducing the laser, its outlet, for the alignment means must be perfectly tight, so as not to perturb the pressure conditions inside the trap.

The device I and the process according to the invention are adapted to numerous applications:
in photo-physico chemistry, for dissociation spectrum measurements, creating MS^{N} spectrums by photodissociation, for measurements of effective photofragmentation section;
in proteomics, for the development of novel methodology for high-rate identification of proteins. In fact, the device and the process according to the invention produce a wide range of fragments, including fragments of very small size, which will increase the efficacy of identification of proteins or peptides. Also, it is possible to carry out successive fragmentation by a controlled stage, starting out from whole proteins or a mixture of proteins, by omitting the stages of electrophoresis and proteins splitting, which are the costliest in terms of time and handling;
for the detection of chemical or bacteriological pollutants, by identifying pollutants by coupling mass spectrometry, and optical spectroscopy. The mass and optical absorption spectrum by laser will provide clear identification of numerous chemical or bacteriological pollutants present in waste water and gases, especially;
for following up on the formation of molecular complexes, by studying the dissociation as a function of the energy of the laser to allow direct determination of the connective energy of the complex;
for studying the photo-induced degradation of molecules, which applies especially to cosmetics, in the environmental field and in biodegradability.

It appears therefore that industrial applications of the process and of the device I according to the invention are numerous, in various fields such as pharmacy, cosmetics, biotechnology, petrochemistry, organometallic chemistry . . . .

By way of illustration, a precise example of a device, such as illustrated in FIG. 2, will now be described. A commercial trap LCQ DUO MS^{N}, thermo electron, was modified to allow it to be coupled to a laser source. The lasers utilised for photo dissociation are:
an Nd:YLF q-switche pump by diode laser (Crystalaser, λ=262 nm and 524 nm),
and a optic parametric oscillator laser (Panther OPO pump by powerlite 8000 Continuum, λ=215 nm at 2.2 μm).

Two mirrors were used to align the laser beam. The laser beam traverses two pinholes 1 mm in diameter, prior to entering, via a quartz window, the chamber of the device, in which reduced pressure of 10⁻⁵ mbar is maintained.

The laser beam is input in the trap by passing through the central ring electrode.

In fact, the central ring electrode was pierced by two diametrically opposed holes 3 mm in diameter, in which two adapters were stuck, such as illustrated in FIG. 3. The first adapter is used for injection of the laser. This is a tube made of insulating material, to the base of which a sapphire window has been stuck. The diameter used enables the laser to fully recover the cloud of ions.

The second adapter is used for the outlet of the laser and the alignment procedure. It is also constituted by a tube made of insulating material with, on one side, a collimation lens of 3 cm and, on the other side, an SMA connexion for fibre optics.

The two adapters are perfectly aligned and stuck perpendicularly to the axis of the electrode which coincides with the axis x of injection and ejection of the ions. The adapters are affixed very tight to gain modification of the assembly which does not alter the helium pressure in the room, necessary for its optimal functioning. No modification of the calibration, the mass resolution and the trapping capacities of the apparatus is induced by the modifications made on the ring electrode.

To effect alignment, fibre optics transmitting UV close to infrared (SENTRONIC) connect the second adapter to an empty passage for fibre optics (SENTRONIC). A second fibre is connected to the outlet of this passage. After the fibre is a removable mirror, a photon detector and a visible laser used for alignment (helium, neon).

To define the axis of alignment for injection of the laser, a visible laser is injected through the fibre optics. Its outlet, through the two windows, defines an optic axis which passes through the centre of the trap and, therefore, through the trapping volume which corresponds to the cloud of ions to be trapped. The two pinholes are then aligned on this axis.

The laser for the photodissociation is thus aligned on the optical axis defined previously, because of mirrors. It must traverse the two pinholes. Detection of the photons leaving the fibre optics allows fine adjustment of the alignment of the laser to the centre of the trap. This detection also allows relative measuring of the power of the injected laser.

The time synchronisation, between injection of the laser into the trap and the radiofrequency voltages applied to the electrodes of the trap, is carried out by an electromechanical shutter controlled by a delay generator slaved on the electronics of the trap.

The dissociation sequences tested, induced by laser, consist of injecting ions from the electrospray source, isolating in the trap an ion of given m/z mass, ejecting the other masses, then over a given time injecting the photodissociation laser. The ions, originating from fragmentation, are then mass-analysed by a conventional procedure. The assembly and synchronisation used for conducting experiments of type MSN by photodissociation (isolation of a mass, photo fragmentation, isolation of a fragment, photodissociation . . . ).

Tryptophan was used as a molecule test.

FIG. 4 shows the photodissociation spectrum of the tryptophan molecule, obtained at λ=262 nm (P=10 mW, irradiation time=10 ms). A spectrum obtained by CID is shown as an inset.

FIG. 5 shows the photodissociation spectrum of tryptophan, as a function of the wavelength of the laser. The spectrum was normalised as a function of the power laser.

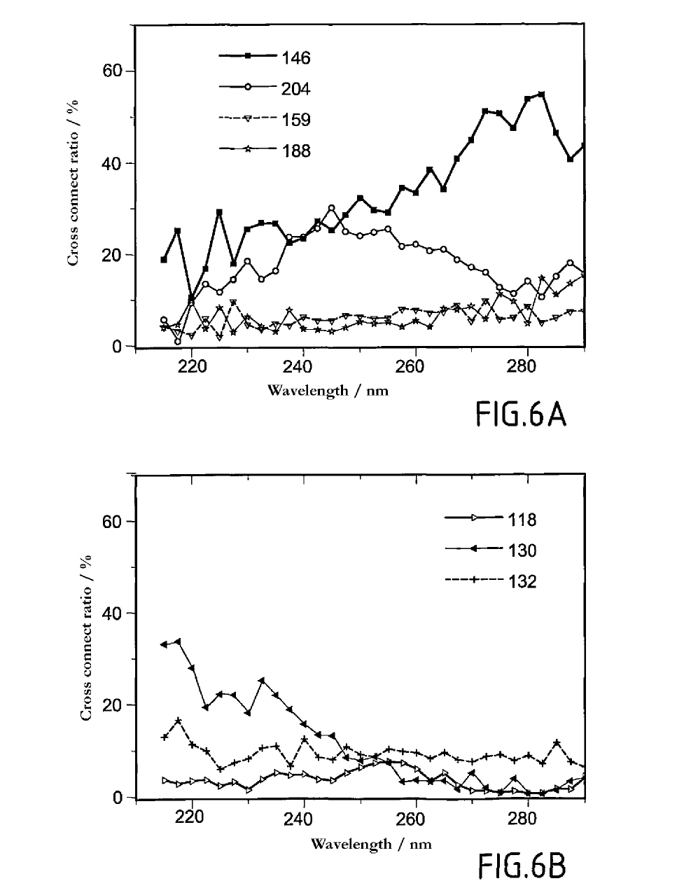

FIGS. 6A and 6B show the evolution of the cross connect ratio measured for the principal fragmentation products of tryptophan, as a function of the wavelength of the photodissociation laser.

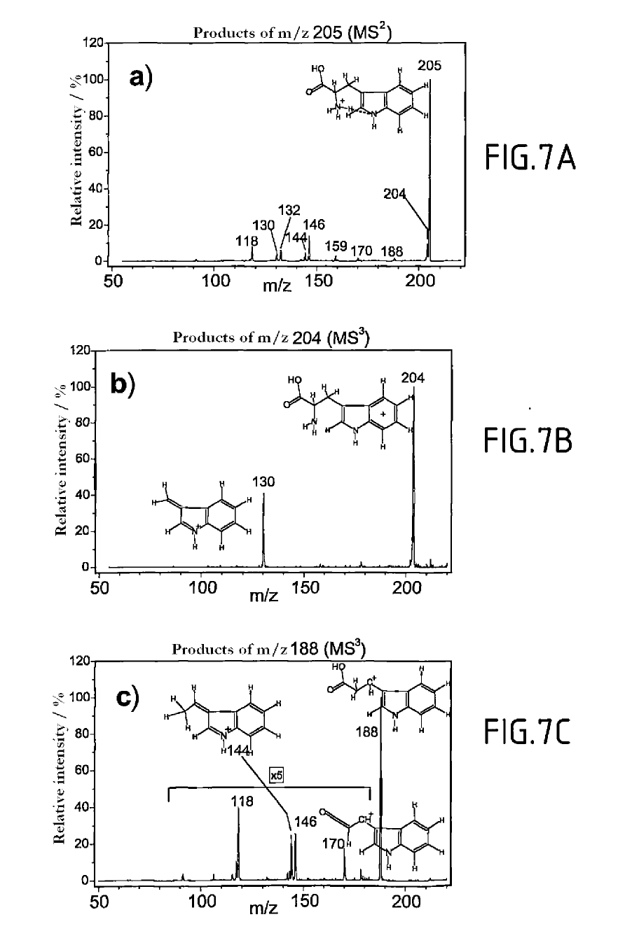

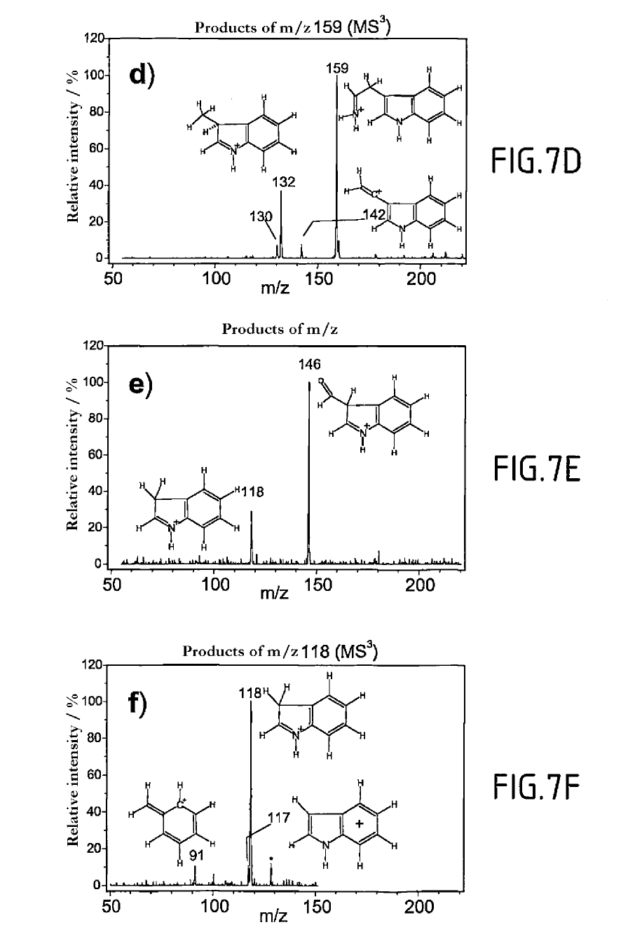

FIGS. 7A to 7F show the dissociation spectrum induced by laser MS³. The molecule of protonated tryptophan (M=205) is injected and isolated in the trap. It is photo-fragmented with λ=265 nm. One of the fragments (M=204, 188, 159, 146 and 118) is isolated, then fragmented in turn. The irradiation time of the laser for each dissociation stage is 300 ms. For each fragment, different types of structures are proposed.

FIG. 8 shows a photodissociation spectrum of Gramicidine D, at λ=262 nm (P=10 mW, irradiation time=300 ms).

1. Device (I) for mass analysis of molecules comprising a quadripolar ion trap (1) equipped with an inlet (2) for injection of the molecules to be analysed in ionised form and an outlet (3) for ejection of the ions to be detected, comprising an electrode system (4) for generating a three-dimensional quadripolar field, capable of selecting the molecules to be analysed in ionised form, as a function of their (m/z) mass to charge ratio and trapping them in a trapping volume (5), said trap (1) being coupled to a UV or visible laser beam (L) ensuring dissociation of the molecules to be analysed in ionised form,
characterised in that the laser beam (L) is introduced to the trap (1), without passing through fibre optics, via an opening (13) made in one of the electrodes, separate from the inlet (2) for injection of the molecules to be analysed in ionised form and from the outlet (3) for ejection of the ions to be detected, and blocked tightly by a viewing window (14) letting the laser beam (L) pass through, the dimension of the viewing window (14) being such that the laser beam covers the entire trapping volume.

2. The device as claimed in claim 1, characterised in that the electrode system (4) is composed of a central annular electrode (10) delimiting a cavity containing the trapping volume (5) and two cap electrodes (11) and (12) situated on either side of the cavity delimited by the annular electrode (10), and in that the inlet (2) for injection of the molecules to be analysed in ionised form is made in one of the cap electrodes (11), the outlet (3) for ejection of the ions to be detected being made in the other cap electrode (12) and the opening (13) for introduction of the laser beam (L) being made in the ring electrode (10).

3. The device as claimed in claim 2, characterised in that injection of the molecules to be analysed in ionised form and ejection of the ions to be detected is done according to parallel and aligned directions (x) and in that the laser beam (L) penetrates in a direction (y) perpendicular to this direction (x) of injection and ejection.

4. The device as claimed in claim 1, characterised in that a laser beam (L) UV is utilised for dissociation of the ionised molecules.

5. The device as claimed in claim 1, characterised in that a laser beam (L) in the form of pulses of the order of a few nanoseconds, picoseconds or femtoseconds is used.

6. The device as claimed in claim 1, characterised in that it comprises alignment means of the laser beam (L) on the trapping volume (5).

7. The device as claimed in claim 1, characterised in that an opening (23) blocked tightly by an element permeable to the laser beam used is made in the quadripolar trap (1), so as to allow the outlet of the trap (1) of the introduced laser beam (L).

8. The device as claimed in claim 7, characterised in that the opening (23) for the outlet of the laser beam is coupled with control means (25) of the alignment of the laser beam.

9. The device as claimed in claim 1, characterised in that it comprises means (26) ensuring synchronisation between introduction of the laser beam to the trap and trapping of the molecules to be analysed in ionised form.

10. A process for mass analysis of molecules using injection of the molecules to be analysed in ionised form in an quadripolar trap (1), selection of molecules to be analysed in ionised form, as a function of their (m/z) mass to charge ratio and their trapping in a trapping volume (5), by means of a three-dimensional quadripolar field generated by an electrode system (4), dissociation of the molecules to be analysed in ionised form trapped in the trapping volume (5) by means of a UV or visible laser beam (L), then ejection of the ions to be detected, characterised in that the laser beam (L) is introduced to the trap (1), without passing through fibre optics via an opening (13) made in one of the electrodes, separate from the inlet (2) for injection of the molecules to be analysed in ionised form and from the outlet (3) for ejection of the ions to be detected, and blocked tightly by a viewing window (14) letting the laser beam (L) pass through, and in such a way that the laser beam covers the entire trapping volume.

11. The process for analysis as claimed in claim 10, characterised in that injection of the molecules to be analysed in ionised form and ejection of the ions to be detected are completed according to parallel and aligned directions (x) and in that introduction of the laser beam (L) is done according to a direction (y) perpendicular to the direction (x) of injection and ejection.

12. The process for analysis as claimed in claim 10, characterised in that a laser beam UV (L) is used for dissociation of ionised molecules.

13. The process for analysis as claimed in claim 10, characterised in that a laser beam in the form of pulses of the order of a few nanoseconds, picoseconds or femtoseconds is used.

14. The process for analysis as claimed in claim 10, characterised in that it comprises a stage of alignment of the laser beam (L) on the trapping volume (5).

15. The process for analysis as claimed in claim 10, characterised in that the outlet of the laser beam (L) introduced to the trap is ensured.

16. The process for analysis as claimed in claim 10, characterised in that after initial dissociation at least one following sequence is used: by regulating of the three-dimensional quadripolar field generated by the electrode system, selection of molecules to be analysed in ionised form originating from the preceding dissociation, as a function of their (m/z) mass to charge ratio and trapping of the latter in the trapping volume, then dissociation of the selected molecules in ionised form.
